(19) United States
(12) Patent Application Publication
(10) Pub. No.: US 2012/0331054 A1
(43) Pub. Date: Dec. 27, 2012

(54) SYSTEM AND METHOD FOR ENABLING UNIVERSAL INTERACTION BETWEEN DEVICES THROUGH INTRINSIC APPLICATIONS

(76) Inventor: SATTAM DASGUPTA, Bangalore (IN)

(21) Appl. No.: 13/366,363

(22) Filed: Feb. 6, 2012

(30) Foreign Application Priority Data
Jun. 25, 2011 (IN) 2146/CHE/2011

(51) Int. Cl. G06F 15/16

(52) U.S. Cl. 709/204

(57) ABSTRACT

A system and method for enabling universal interaction between a plurality of devices through intrinsic applications (IAs) are disclosed. In one embodiment, a specific IA, having a specific configuration and software environment that support applications that run on a first device of the plurality of devices, is obtained by the first device from a plurality of IAs of a second device of the plurality of devices, from a central server connected via a network or a local storage of the second device. The plurality of IAs is configured to have different specific configurations and software environments that run on the plurality of devices. The software environments of the first device and second device are same or different. Further, the obtained specific IA is installed by the first device. Furthermore, the installed specific IA is executed on the first device to enable interaction between the first device and second device.

Benefit is claimed under 35 U.S.C 119(a) to Indian Provisional Application Ser. No. 2146/CHE/2011 entitled “Universal interactivity between devices through intrinsic applications” by Ittiam Systems (P) Ltd filed on Jun. 25, 2011.

### FIELD OF TECHNOLOGY

Embodiments of the present invention relate to universal interaction between devices. More particularly, embodiments of the present invention relate to universal interaction between the devices through intrinsic applications (IAs).

### BACKGROUND

In the past, devices with embedded electronics were largely standalone. Currently, there is an increasing trend for connection and interaction between the devices through physical link(s) using a plurality of protocols. Exemplary devices include a tablet, a video phone, a personal computer (PC), a laptop, a camcorder, a light, a washing machine, a fridge, an automobile, a digital photo frame, a surveillance camera, a mobile phone, a home automation system, a television (TV), a home appliance, an industrial appliance and the like. Exemplary physical link includes at least one of a wired link including a universal serial bus (USB), a local area network (LAN), power line communication and the like and a wireless link including Bluetooth®, a wireless local area network (WLAN), near field communication (NFC), a cellular network and the like. Typically, various methods and protocols are used to enable connection and interaction between the devices. Today, connectivity or networking between the devices is an overwhelming trend that is expected to dominate as the connectivity between the devices increases.

Although, increasingly the devices are getting connected with each other, their ability to interact with each other is limited for multiple reasons. One being, multiple protocols for communication between the devices and the other being, lack of mutual understanding of each other's capabilities, such as functionalities, performance, interface capabilities, connectivity options and the like of the devices they are connected to.

In order for the devices to have more elaborate and meaningful connectivity and interaction, each of these devices needs to have prior knowledge of capabilities of the other devices. Further, these devices need to have a common language by which they can communicate with each other to leverage each other's capabilities.

Currently, the interaction between the devices is achieved to a limited extent by having a specialized hardware and software that allow a defined and limited connectivity and interaction between the devices. For example, for a personal computer (PC) to stream a video to a mobile phone over the WLAN, the PC needs to have streaming server software and the mobile phone needs to have streaming client software and both the streaming server software and streaming client software have to be based on a common streaming protocol and support a common video format so that the PC may stream the video and the mobile phone may receive and play the streamed video.

Therefore, existing devices are inherently limited in interaction with each other because of lack of the common language or protocol between the devices and prior understanding of each other's capabilities and also because of the need for the specialized hardware and software that need to be developed for a myriad of combinations of connected devices and their functionalities. In recent time, however, the devices are increasingly having one or more processors with a software environment or an operating system (OS) that is designed to provide standardized interfaces for developing software programs and to provide standardized software interfaces to access and control underlying hardware of the devices to support the software programs or applications that can work on the devices which support the software environment or OS. Exemplary software environments include Android®, Meego®, iOS®, and so on. Further, the applications with a specific functionality, to deliver the specific functionality across a plurality of devices, are being made available for various software environments in associated application stores. The application stores are nothing but remote servers on a network which store the applications. In addition, the applications can also be stored in a local storage of the devices, such as an internal memory or a hard disc of the devices.

### BRIEF DESCRIPTION OF THE DRAWINGS

Various embodiments are described herein with reference to the drawings, wherein:

FIG. 1 illustrates a flow chart of a method for enabling universal interaction between a plurality of devices through intrinsic applications (IAs) and IA monitor applications (IMAs), according to one embodiment;

FIG. 2 is a block diagram illustrating universal interaction between the plurality of devices through the IAs, using the process described with reference to FIG. 1, according to one embodiment;

FIG. 3 is a block diagram illustrating universal interaction between the plurality of devices through the IAs and IMAs, using the process described with reference to FIG. 1, according to one embodiment; and

FIG. 4 is a block diagram illustrating an exemplary implementation of the interaction between the plurality of devices through the IAs and IMAs, using the process described with reference to FIG. 1, according to one embodiment.

Other features of the present embodiments will be apparent from the accompanying drawings and from the detailed description that follows.

### DETAILED DESCRIPTION

A system and method for enabling universal interaction between devices through intrinsic applications (IAs) and optionally IA monitor applications (IMAs) are disclosed. In the following detailed description of the embodiments of the invention, references are made to the accompanying drawings that form a part hereof, and in which are shown, by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

The term “application” here refers to a software program that runs on a device with processor(s) and a software environment or an operating system (OS). Further, the term “device” here refers to an apparatus with embedded electronics, i.e., any apparatus that has software running in it with an OS that has standardized interfaces for developing software programs or applications and provides standardized software interfaces to access and control the underlying hardware to support the software programs or applications that can work on the apparatus which supports the specific software environment or OS. Further, the embedded electronics in the apparatus supports electronic connectivity over one or more physical links which in turn support one or more connectivity protocols.

Even though the entire specification recites the interaction between a first device of a plurality of devices and a second device of the plurality of devices using associated IAs and IMAs, one can envision that the below technique can be applied for interaction between the plurality of devices using the IAs and IMAs.

The present invention provides an IA and optionally an IMA that are specific to devices with a specific configuration, such as hardware, software, and so on and having a software environment or an OS that support applications that run on devices which have the same software environment.

The IA of a device is designed to comprehend capabilities, such as functionalities, performance, interfaces, protocols and other such capabilities supported by the device. The IA is designed to run on other devices to enable the other devices to connect, access, interoperate, control and/or perform any other operation as defined by the IA of the device. Versions of the IA are made available for different OSs which the other devices run. Further, the IA of the device can be stored in a local storage, such as an internal memory, a hard disc and the like of the device and can be shared with the other devices or the IA of the device can be downloaded from a central server connected via a network by the other devices.

The IMA of the device is designed to run on the device and to interact with the corresponding IA running on the other devices to track and monitor the interaction between the devices, authenticate the other devices for connection, authorize the other devices for data and functionality access depending on authorization levels, allow direct access of functions wherever possible and the like. The IMA can also be configured to offer management capabilities on the device for managing the other devices that have the corresponding IA of the device. The IMA runs on the device and enables connection and interaction of the device with the other devices, including same, similar or different functionalities, which have the corresponding IA loaded and running on them.

In one embodiment, the IA and IMA of the device, supplied by a manufacturer of the device, use one or more standard based protocols and/or one or more proprietary protocols for interaction. Optionally, the IA and/or IMA of the device can be developed and supplied by an independent vendor if the software determined functionality and an application programming interface (API) of the software environment of the device are made available by the manufacturer of the device.

The device can be loaded with the IMA, for running on the device, by either the manufacturer or can also be downloaded from the central server (e.g., an application store on a remote server). Also, the device can be loaded with the corresponding IA in the local storage of the device, for sharing with the other devices and also for running on the other devices, by either the manufacturer or can be downloaded from the central server. The software environments of the device and other devices can be same or different. The other devices which need to connect and interact with the device can be loaded with the corresponding IA of the device by either downloading the corresponding IA from the central server or by obtaining directly from the local storage of the device via a physical link or by copying the corresponding IA into a temporary storage from the local storage of the device and transferring the corresponding IA from the temporary storage to the other devices. Exemplary physical link includes at least one of a wired link including a universal serial bus (USB), a local area network (LAN), power line communication and the like and a wireless link including Bluetooth®, a wireless local area network (WLAN), near field communication (NFC), a cellular network and the like. Exemplary temporary storage includes a USB memory stick, a secure digital (SD) card and the like.

Further, the device can download the corresponding IA of each of the other devices from the central server or directly obtain the corresponding IA of each of the other devices from an associated local storage of the other devices via the physical link or by copying the corresponding IA of each of the other devices into the temporary storage from the associated local storage of each of the other devices and transferring the corresponding IA from the temporary storage to the device.

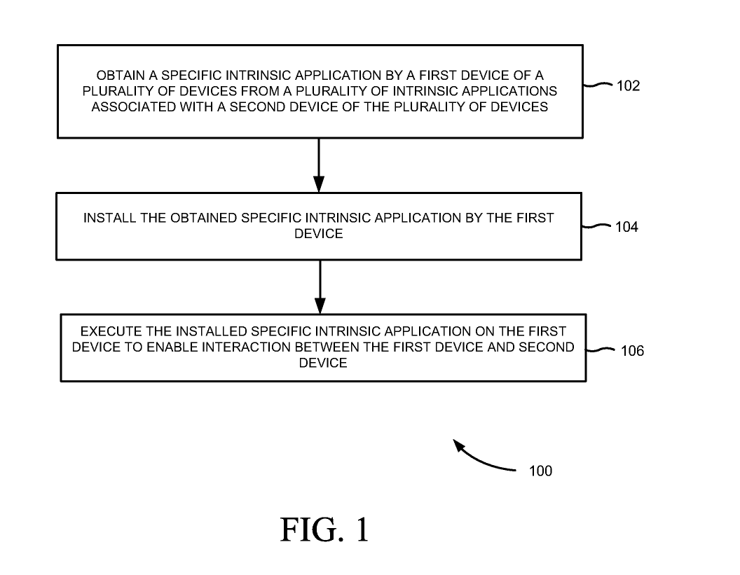

FIG. 1 illustrates a flow chart 100 of a method for enabling universal interaction between a plurality of devices through IAs and IMAs, according to one embodiment. Exemplary devices include a tablet, a video phone, a personal computer (PC), a laptop, a camcorder, a light, a washing machine, a fridge, an automobile, a digital photo frame, a surveillance camera, a mobile phone, a home automation system, a television (TV), a home appliance, an industrial appliance and the like. At block 102, a specific IA, having a specific configuration and a software environment that support applications that run on a first device of the plurality of devices, is obtained by the first device from a plurality of IAs associated with a second device of the plurality of devices from a central server connected via a network or from a local storage of the second device. The software environments of the first device and second device can be same or different. Exemplary network includes a LAN, a wide area network (WAN), a WLAN, and the like.

In one embodiment, the specific IA is obtained from the local storage of the second device by the first device via a physical link or by copying the specific IA into a temporary storage from the local storage of the second device and transferring the specific IA from the temporary storage to the first device. Exemplary physical link includes at least one of a wired link including a USB, the LAN, power line communication and the like and a wireless link including Bluetooth®, the WLAN, NFC, a cellular network and the like. Exemplary temporary storage includes a USB memory stick, a SD card and the like. The plurality of IAs is configured to have different specific configurations and software environments that run on the plurality of devices. For example, the specific configuration includes a hardware configuration and/or a software configuration. For example, each of the plurality of IAs is designed to comprehend capabilities, such as functionalities, performance, interfaces, and protocols supported by the second device. For example, the interfaces refer to connectivity interfaces, input/output (I/O) interfaces and the like. For example, the central server includes a plurality of IAs and an IMA associated with each of the plurality of devices. In one embodiment, the plurality of IAs associated with the second device is loaded in the local storage of the second device during manufacturing of the second device. In another embodiment, the plurality of IAs associated with the second device is obtained from the central server and stored in the local storage by the second device.

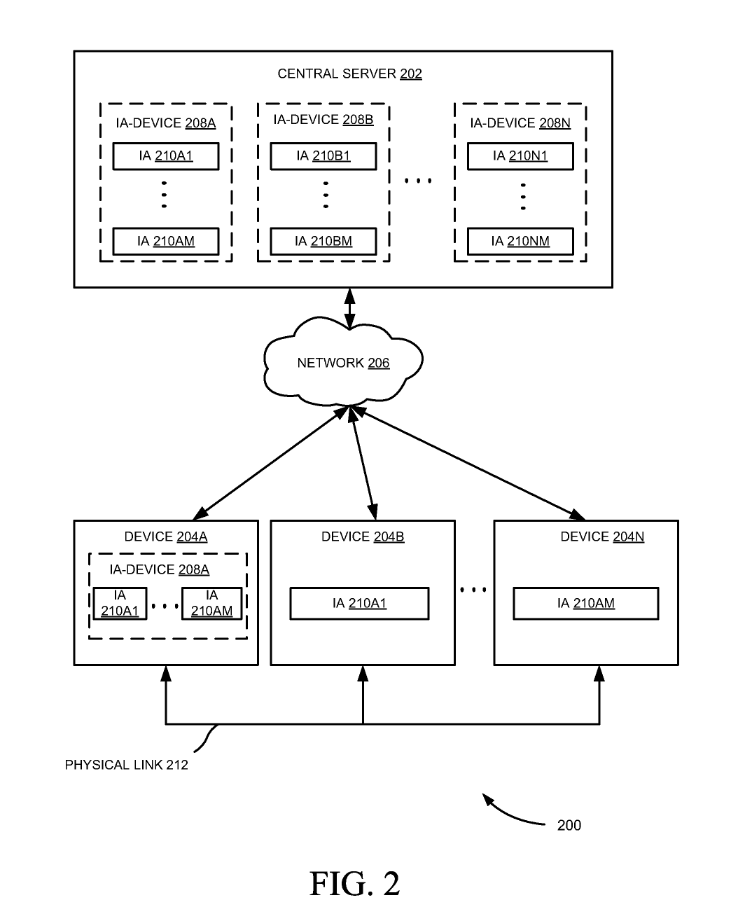

At block 104, the obtained specific IA is installed by the first device. At block 106, the installed specific IA is executed or run on the first device to enable interaction between the first device and second device. For example, the interaction includes interactivity parameters, such as connect, access, interoperate, control and perform any other operation as defined by the specific IA. The specific IA is designed to run on the first device to connect, access, interoperate, control or perform any other operation on the second device as defined by the specific IA. This is explained in more detail with reference to FIG. 2.

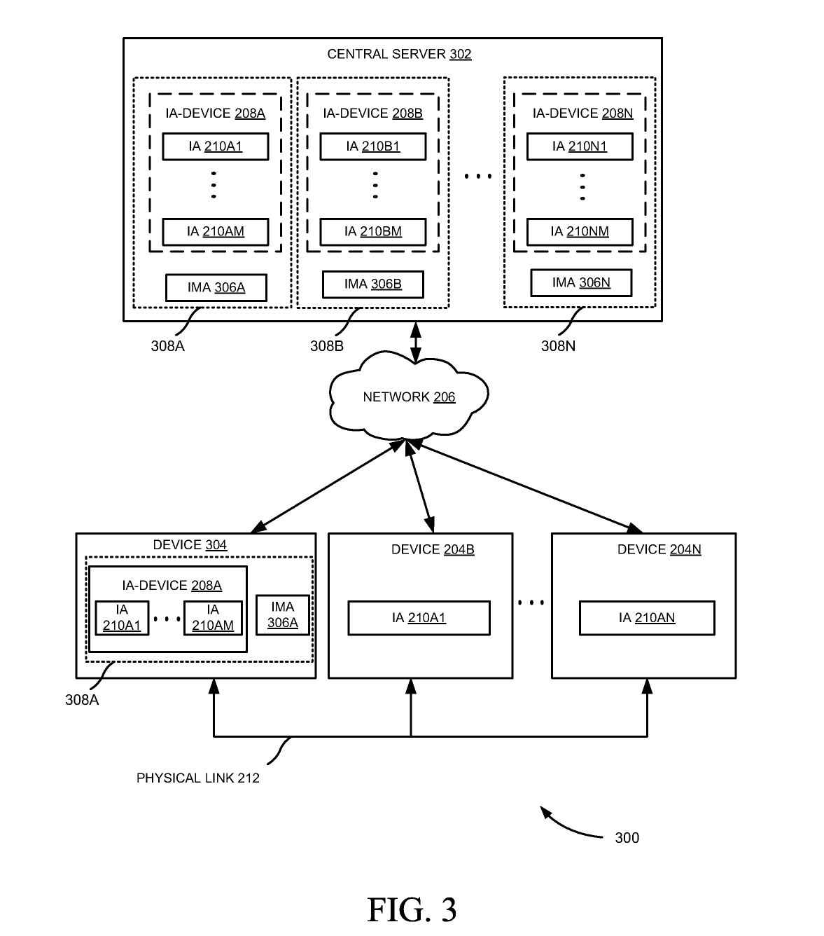

In one embodiment, the first device is authenticated by an IMA, as shown in FIG. 3, associated with the second device. In one exemplary implementation, a connection is established between the first device and second device using a common physical link and protocol. Further, the first device is authenticated by the IMA associated with the second device using a predefined authentication procedure between the specific IA installed and running on the first device and the IMA installed and running on the second device upon establishing the connection. The IMA exists in at least one of the local storage of the second device and the central server. In one embodiment, the IMA is loaded in the local storage of the second device during manufacturing of the second device. In another embodiment, the IMA associated with the second device is obtained from the central server and stored in the local storage by the second device. The IMA of the second device is designed to be executed or run on the second device. Further, the first device or the specific IA running on the first device is authorized by the IMA associated with the second device upon authentication. Furthermore, authentication information, such as an identity and the like and timestamp information, such as date and time of authentication and the like associated with the first device are recorded by the IMA associated with the second device upon the authorization. In addition, interaction between the first device and second device is enabled upon recording the authentication information and timestamp information.

In this embodiment, the IMA running on the second device is configured to interact with the specific IA running on the first device to enable connection and interaction between the first device and the second device after authenticating the first device for connection, authorizing the first device for data and functionality access depending on authorization levels, and allowing direct access of functions wherever possible. Further, the IMA running on the second device tracks, monitors and records the interaction between the first device and second device. The IMA of the second device can also be configured to offer management capabilities for managing the first device that has the specific IA associated with the second device. This is explained in more detail with reference to FIG. 3.

Referring now to FIG. 2, which is a block diagram 200 illustrating universal interaction between a plurality of devices 204A-N through a plurality of IAs 210A1-AM to 210N1-NM, using the process described with reference to FIG. 1, according to one embodiment. As shown in FIG. 2, the block diagram 200 includes a central server 202 and the devices 204A-N. Further as shown in FIG. 2, the central server 202 includes IA-devices 208A-N associated with the devices 204A-N. Furthermore as shown in FIG. 2, the IA-devices 208A-N include the plurality of IAs 210A1-AM to 210N1-NM, respectively. The IAs 210A1-AM to 210N1-NM are configured to have different specific configurations and software environments that run on the devices 204A-N. In addition as shown in FIG. 2, the devices 204A-N are connected to the central server 202 via a network 206. Exemplary network includes a LAN, a WAN, a WLAN, and the like. Moreover, the devices 204A-N are connected to each other via a physical link 212. Even though FIG. 2 shows one physical link 212 between the devices 204A-N, there can be multiple physical links between the devices 204A-N. Exemplary physical link includes at least one of a wired link including a USB, a LAN, power line communication and the like and a wireless link including Bluetooth®, a WLAN, NFC, a cellular network and the like.

In operation, a specific IA, for example, 210A1, having a specific configuration and a software environment that support applications that run on a first device, for example, 204B, of the devices 204A-N, is obtained by the first device 204B from the IAs 210A1-AM in the IA-device 208A associated with a second device, for example, 204A, of the devices 204A-N, from the central server 202 connected via the network 206 or a local storage of the second device 204A. The software environments of the first device 204B and second device 204A can be same or different. In one embodiment, the specific IA 210A1 is obtained from the local storage of the second device 204A by the first device 204B via the physical link 212 or by copying the specific IA 210A1 into a temporary storage from the local storage of the second device 204A and transferring the specific IA 210A1 from the temporary storage to the first device 204B. Exemplary temporary storage includes a USB memory stick, a SD card and the like.

Each of the IAs 210A1-AM in the IA-device 208A is configured to comprehend capabilities of the second device 204A. Particularly, the capabilities of the second device 204A comprehended by each of the IAs 210A1-AM in the IA-device 208A include feasible modes of connection with the second device 204A, protocols for communicating with the second device 204A for access and control functionalities supported by the second device 204A, authentication for use, authorization for types of use, levels of access and control and the like. In one embodiment, the IAs 210A1-AM are loaded in the local storage of the second device 204A during manufacturing of the second device 204A. In another embodiment, the IAs 210A1-AM are obtained from the central server 202 and stored in the local storage of the second device 204A.

Further in operation, the obtained specific IA 210A1 is installed by the first device 204B. Furthermore, the installed specific IA 210A1 is executed on the first device 204B to enable interaction between the second device 204A and first device 204B. For example, interaction includes interactivity parameters, such as connect, access, interoperate, control and perform any other operation defined by the specific IA 210A1. The specific IA 210A1 is designed to be executed on the first device 204B to connect, access, interoperate, control or perform any other operation on the second device 204A as defined by the specific IA 210A1. In some embodiments, the interaction between the second device 204A and first device 204B using the specific IA 210A1 may be limited and can be further enhanced using an IMA (such as an IMA 306A, shown in FIG. 3) along with the specific IA 210A1 of the second device 204A. This is explained in more detail with reference to FIG. 3.

Referring now to FIG. 3, which is a block diagram 300 illustrating universal interaction between a plurality of devices 304 and 204B-N through the IAs 210A1-AM to 210N1-NM and IMAs 306A-N, using the process described with reference to FIG. 1, according to one embodiment. As shown in FIG. 3, the block diagram 300 includes a central server 302 and the devices 304 and 204B-N. Further as shown in FIG. 3, the central server 302 includes IA-devices 208A-N and the IMAs 306A-N associated with the devices 304 and 204B-N. Furthermore as shown in FIG. 3, the IA-devices 208A-N include the IAs 210A1-AM to 210N1-NM, respectively. The IAs 210A1-AM to 210N1-NM are configured to have different specific configurations and software environments that run on the devices 304 and 204B-N. In addition as shown in FIG. 3, the devices 304 and 204B-N are connected to the central server 302 via the network 206. Moreover, the devices 304 and 204B-N are connected to each other via the physical link 212. Even though FIG. 3 shows one physical link 212 between the devices 304 and 204B-N, there can be multiple physical links between the devices 304 and 204B-N.

In one embodiment, the central server 302 can be configured to have management functionalities for monitoring, tracking, and/or updating the IMAs 306A-N and/or IAs 210A1-AM to 210N1-NM in the IA-devices 208A-N of the devices 304 and 204B-N, respectively, and also manage the devices' network. The network of a device includes a plurality of devices having an IA corresponding to the device.

In operation, a specific IA, for example, 210A1, having a specific configuration and a software environment that support applications that run on the first device 204B is obtained by the first device 204B from the IAs 210A1-AM in the IA-device 208A associated with a second device, for example, 304, of the devices 304 and 204B-N, from the central server 302 or a local storage of the second device 304. The software environments of the first device 204B and second device 304 can be same or different. In one embodiment, the specific IA 210A1 is obtained from the local storage of the second device 304 by the first device 204B via the physical link 212 or by copying the specific IA 210A1 into the temporary storage from the local storage of the second device 304 and transferring the specific IA 210A1 from the temporary storage to the first device 204B.

Each of the IAs 210A1-AM in the IA-device 208A is configured to comprehend capabilities of the second device 304. Particularly, the capabilities of the second device 304 comprehended by each of the IAs 210A1-AM in the IA-device 208A include feasible modes of connection with the second device 304, protocols for communicating with the second device 304 for access and control functionalities supported by the second device 304, authentication for use, authorization for types of use, levels of access and control and the like. In one embodiment, the IAs 210A1-AM are loaded in the local storage of the second device 304 during manufacturing of the second device 304. In another embodiment, the IAs 210A1-AM are obtained from the central server 302 and stored in the local storage of the second device 304.

Further in operation, the obtained specific IA 210A1 is installed by the first device 204B. Furthermore, the installed specific IA 210A1 is executed on the first device 204B to enable interaction between the second device 304 and first device 204B. For example, interaction includes interactivity parameters, such as connect, access, interoperate, control and perform any other operation defined by the specific IA 210A1. The specific IA 210A1 is designed to be executed or run on the first device 204B to connect, access, interoperate, control or perform any other operation on the second device 304 as defined by the specific IA 210A1. In one embodiment, the first device 204B is authenticated by the IMA 306A associated with the second device 304. In one exemplary implementation, a connection is established between the first device 204B and the second device 304 using a common physical link and protocol. Further, the first device 204B is authenticated by the IMA 306A associated with the second device 304 using a predefined authentication procedure between the specific IA 210A1 installed and running on the first device 204B and the IMA 306A installed and running on the second device 304 upon establishing the connection.

Further in this embodiment, the first device 204B or the specific IA 210A1 running on the first device 204B is authorized by the IMA 306A based on the authentication. In one embodiment, the IMA 306A in the second device 304 authenticates and authorizes the first device 204B before giving access to the specific IA 210A1. Furthermore, authentication information, such as an identity and the like and timestamp information, such as date and time of authentication and the like of the first device 204B are recorded by the IMA 306A associated with the second device 304 upon the authorization. In addition, interaction between the first device 204B and second device 304 is enabled upon recording the authentication information and timestamp information.

Further, in some embodiments, the functionalities of the IMA 306A can be enhanced to provide increased interactivity with the first device 204B by additional built-in functionalities in the IMA 306A.

In this embodiment, the IMA 306A running on the second device 304 is configured to interact with the specific IA 210A1 running on the first device 204B to enable connection and interaction of the first device 204B with the second device 304 after authenticating the first device 204B for connection, authorizing the first device 204B for data and functionality access depending on authorization levels, and allowing direct access of functions wherever possible. Further, the IMA 306A running on the second device 304 tracks, monitors and records the interaction between the first device 204B and second device 304. The IMA 306A of the second device 304 can also be configured to offer management capabilities for managing the first device 204B that has the specific IA 210A1 of the second device 304.

For example, consider a laptop as the first device 204B and a home automation system as the second device 304. The home automation system can be loaded with a corresponding IMA and plurality of IAs by a manufacturer of the home automation system or the home automation system can be configured to download the corresponding IMA and IAs from the central server 302. In one embodiment, the laptop is configured to directly obtain a specific IA from the plurality of IAs associated with the home automation system, via the physical link 212, to enable the laptop to connect, access, interoperate, control and/or perform any other operation on the home automation system through the corresponding IMA and as defined by the specific IA. The specific IA has a specific configuration and a software environment that support applications that run on the laptop. In another embodiment, the specific IA of the home automation system can also be obtained from the central server 302 by the laptop to enable the laptop to connect, access, interoperate, control and/or perform any other operation on the home automation system through the corresponding IMA and as defined by the specific IA. With the above described technique, the laptop and home automation system can connect and interact with each other using corresponding IMA and IAs without any limitations of protocols, prior understanding of supported functionalities and/or requiring specially designed hardware and/or software.

In some embodiments, the home automation system may include functionalities that are not designed to directly interact with the laptop even through the corresponding IA. In such a scenario, the functionalities of the IMA in the home automation system can be enhanced to enable the interaction.

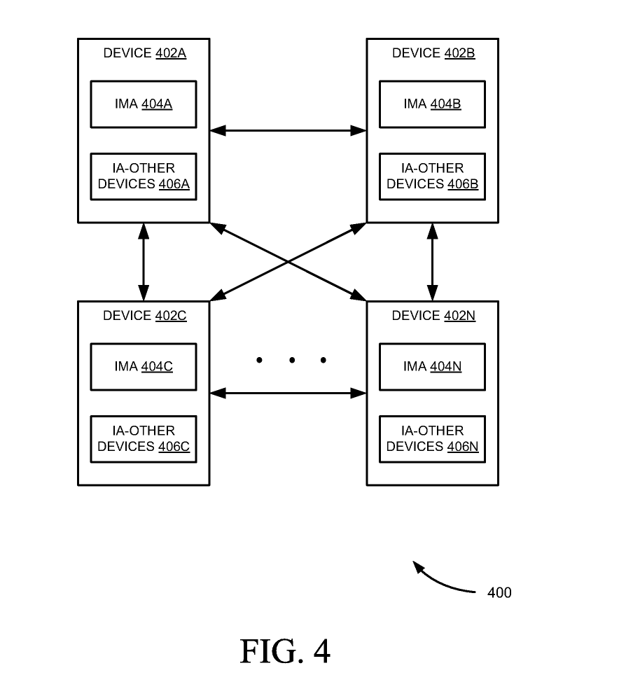

Referring now to FIG. 4, which is a block diagram 400 illustrating an exemplary implementation of interaction between a plurality of devices 402A-N through IAs and IMAs, using the process described with reference to FIG. 1, according to one embodiment. As shown in FIG. 4, each of the plurality of devices 402A-N includes an associated one of IMAs 404A-N and an associated one of IA-other devices 406A-N. For example, the IA-other devices 406A in the device 402A includes IAs associated with the devices 402B-N. Further as shown in FIG. 4, the plurality of device 402A-N are connected to each other via one or more physical links which in turn support one or more connectivity protocols. For example, the device 402A enables the devices 402B-N, to access, control and interact with the device 402A by using an IA of the device 402A. Further, the device 402A can access, control and interact with the devices 402B-N by using IAs of the devices 402B-N, respectively.

In various embodiments, the system and method described in FIGS. 1 through 4 enable universal interaction between the plurality of devices through the IAs and optionally the IMAs. The above technique enables universal interaction between the plurality of devices without the need for a common protocol and comprehension of each other devices' functionalities.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method for enabling universal interaction between a plurality of devices through intrinsic applications (IAs), comprising:
obtaining by a first device of the plurality of devices a specific IA, having a specific configuration and a software environment that support applications that run on the first device, from a plurality of IAs, that are configured to have different specific configurations and software environments that run on the plurality of devices, associated with a second device of the plurality of devices, from a central server connected via a network or a local storage of the second device, wherein the software environments of the first device and second device are same or different;
installing the obtained specific IA by the first device; and
executing the installed specific IA on the first device to enable interaction between the first device and the second device.

2. The method of claim 1, wherein obtaining the specific IA from the local storage of the second device by the first device comprises:
obtaining the specific IA from the local storage of the second device by the first device via a physical link or by copying the specific IA into a temporary storage from the local storage of the second device and transferring the specific IA from the temporary storage to the first device.

3. The method of claim 2, wherein the physical link comprises at least one of a wired link including a universal serial bus (USB), a local area network (LAN) and power line communication and a wireless link including Bluetooth®, a wireless local area network (WLAN), near field communication (NFC) and a cellular network.

4. The method of claim 2, wherein the temporary storage is selected from the group consisting of a USB memory stick and a secure digital (SD) card.

5. The method of claim 1, wherein executing the installed specific IA on the first device to enable interaction between the first device and the second device comprises:
authenticating the first device by an IA monitor application (IMA) associated with the second device;
authorizing the first device or the specific IA running on the first device by the IMA associated with the second device based on the authentication;
recording authentication information and timestamp information of the first device by the IMA associated with the second device upon the authorization; and
enabling interaction between the first device and second device upon recording the authentication information and timestamp information.

6. The method of claim 5, wherein authenticating the first device by the IMA associated with the second device comprises:
establishing a connection between the first device and second device using a common physical link and protocol; and
authenticating the first device by the IMA using a predefined authentication procedure between the specific IA installed and running on the first device and the IMA installed and running on the second device upon establishing the connection.

7. The method of claim 5, wherein the authentication information comprises an identity of the first device.

8. The method of claim 5, wherein the timestamp information comprises date and time of authentication of the first device.

9. The method of claim 5, wherein the central server comprises a plurality of IAs and an IMA associated with each of the plurality of devices.

10. The method of claim 9, wherein the plurality of IAs and IMA associated with the second device are obtained from the central server and stored in the local storage by the second device.

11. The method of claim 5, wherein the plurality of IAs and IMA associated with the second device are loaded in the local storage of the second device during manufacturing of the second device.

12. The method of claim 1, wherein the specific configuration comprises a hardware configuration and/or a software configuration.

13. The method of claim 1, wherein each of the plurality of IAs is designed to comprehend capabilities, of the second device, selected from the group consisting of functionalities, performance, interfaces, and protocols supported by the second device.

14. The method of claim 1, wherein the interaction comprises interactivity parameters selected from the group consisting of connect, access, interoperate, control and perform any other operation defined by the specific IA.

15. The method of claim 1, wherein the plurality of devices comprises devices selected from the group consisting of a tablet, a video phone, a personal computer (PC), a laptop, a camcorder, a light, a washing machine, a fridge, an automobile, a digital photo frame, a surveillance camera, a mobile phone, a home automation system, a television (TV), a home appliance and an industrial appliance.

16. A system for enabling universal interaction between a plurality of devices through intrinsic applications (IAs), comprising:
a central server; and
the plurality of devices connected to the central server via a network, wherein a first device of the plurality of devices obtains a specific IA, having specific configuration and a software environment that support applications that run on the first device, from a plurality of IAs, that are configured to have different specific configurations and software environments that run on the plurality of devices, associated with a second device of the plurality of devices, from a central server connected via the network or a local storage of the second device, wherein the software environments of the first device and second device are same or different, wherein the first device installs the obtained specific IA, and wherein the first device executes the installed specific IA to enable interaction between the first device and the second device.

17. The system of claim 16, wherein the first device is configured to:
obtain the specific IA from the local storage of the second device via a physical link or by copying the specific IA into a temporary storage from the local storage of the second device and transferring the specific IA from the temporary storage to the first device.

18. The system of claim 17, wherein the physical link comprises at least one of a wired link including a universal serial bus (USB), a local area network (LAN) and power line communication and a wireless link including Bluetooth®, a wireless local area network (WLAN), near field communication (NFC) and a cellular network.

19. The system of claim 17, wherein the temporary storage is selected from the group consisting of a USB memory stick and a secure digital (SD) card.

20. The system of claim 16, wherein the second device is configured to:
authenticate the first device by an IA monitor application (IMA) associated with the second device;
authorize the first device or the specific IA running on the first device by the IMA associated with the second device based on the authentication;
record authentication information and timestamp information of the first device by the IMA associated with the second device upon the authorization; and
enable interaction between the first device and second device upon recording the authentication information and timestamp information.

21. The system of claim 20, wherein the second device is configured to:
establish a connection between the first device and the second device using a common physical link and protocol; and
authenticate the first device using a predefined authentication procedure between the specific IA installed and running on the first device and the IMA installed and running on the second device upon establishing the connection.

22. The system of claim 20, wherein the authentication information comprises an identity of the first device.

23. The system of claim 20, wherein the timestamp information comprises date and time of authentication of the first device.

24. The system of claim 20, wherein the central server comprises a plurality of IAs and an IMA associated with each of the plurality of devices.

25. The system of claim 24, wherein the second device is configured to:
obtain the plurality of IAs and IMA associated with the second device from the central server and store in the local storage of the second device.

26. The system of claim 20, wherein the plurality of IAs and IMA are associated with the second device loaded in the local storage of the second device during manufacturing of the second device.

27. The system of claim 16, wherein the specific configuration comprises a hardware configuration and/or a software configuration.

28. The system of claim 16, wherein each of the plurality of IAs is designed to comprehend capabilities, of the second device, selected from the group consisting of functionalities, performance, interfaces, and protocols supported by the second device.

29. The system of claim 16, wherein the interaction comprises interactivity parameters selected from the group consisting of connect, access, interoperate, control and perform any other operation defined by the specific IA.

30. The system of claim 16, wherein the plurality of devices comprises devices selected from the group consisting of a tablet, a video phone, a personal computer (PC), a laptop, a camcorder, a light, a washing machine, a fridge, an automobile, a digital photo frame, a surveillance camera, a mobile phone, a home automation system, a television (TV), a home appliance and an industrial appliance.

31. A method for enabling universal interaction between a plurality of devices through intrinsic applications (IAs), comprising:
obtaining by a first device of the plurality of devices a specific IA, having a specific configuration and a software environment that support applications that run on the first device, from a plurality of IAs, that are configured to have different specific configurations and software environments that run on the plurality of devices, associated with a second device of the plurality of devices, from a central server connected via a network or a local storage of the second device, wherein the software environments of the first device and second device are same or different; and
installing the obtained specific IA by the first device to enable interaction between the first device and the second device.

32. The method of claim 31, further comprising:
executing the installed specific IA on the first device.

33. The method of claim 31, wherein obtaining the specific IA from the local storage of the second device by the first device comprises:
obtaining the specific IA from the local storage of the second device by the first device via a physical link or by copying the specific IA into a temporary storage from the local storage of the second device and transferring the specific IA from the temporary storage to the first device.

34. The method of claim 32, wherein executing the installed specific IA on the first device comprises:
authenticating the first device by an IA monitor application (IMA) associated with the second device;
authorizing the first device or the specific IA running on the first device by the IMA associated with the second device based on the authentication;
recording authentication information and timestamp information of the first device by the IMA associated with the second device upon the authorization; and
enabling interaction between the first device and second device upon recording the authentication information and timestamp information.

35. The method of claim 34, wherein the central server comprises a plurality of IAs and an IMA associated with each of the plurality of devices.

36. The method of claim 35, wherein the plurality of IAs and IMA associated with the second device are obtained from the central server and stored in the local storage by the second device.

37. The method of claim 34, wherein the plurality of IAs and IMA are loaded in the local storage of the second device during manufacturing of the second device.
